(19) United States
(12) Patent Application Publication
(10) Pub. No.: US 2013/0268603 A1
(43) Pub. Date: Oct. 10, 2013

(54) SYSTEMS AND METHODS OF COMMUNICATING IN A NETWORKING ENVIRONMENT

(71) Applicants: Majed Saeed M. ALDOSARI, Riyadh (SA); Mohammad Sulaiman KHORSHEED, Riyadh (SA)

(72) Inventors: Majed Saeed M. ALDOSARI, Riyadh (SA); Mohammad Sulaiman KHORSHEED, Riyadh (SA)

(21) Appl. No.: 13/443,311

(22) Filed: Apr. 10, 2012

(51) Int. Cl. G06F 15/16

(52) U.S. Cl. 709/206

(57) ABSTRACT

Systems and methods of communicating in a networking environment is disclosed. The method is implemented in a computer infrastructure having computer executable code tangibly embodied on a computer readable storage medium having programming instructions. The program instructions are operable to: obtain a selectable list of mutual channels or friends of the user and a current contact or friend within a networking environment; provide the selectable list of mutual channels or friends to the user with a fillable field for a message; and send the message to selected mutual channels or friends provided on the selectable list of mutual channels or friends.

### FIELD OF THE INVENTION

The invention relates to networking environments and, more particularly, to systems and methods of communicating in a networking environment.

### BACKGROUND OF THE INVENTION

Social networking environments are ubiquitous in today's electronic information age. Social networking environments can range from business networks to purely social networks or any combination thereof. These social network environments provide an important role in communicating with contacts and friends. For example, these social networking environments provide a mechanism for contacts and friends to keep in touch with one another, to make new friends and contacts through social environments, as well as conduct business and provide personal information or events for all friends to view and comment upon. However, social networking environments are limited in the way that they can provide communication between users, friends and contacts, and importantly between users and mutual channels with current friends.

Accordingly, there exists a need in the art to overcome the deficiencies and limitations described hereinabove.

### SUMMARY OF THE INVENTION

In a first aspect of the invention, a method is implemented in a computer infrastructure having computer executable code tangibly embodied on a computer readable storage medium having programming instructions. The program instructions are operable to: obtain a selectable list of mutual channels or friends of the user and a current contact or friend within a networking environment; provide the selectable list of mutual channels or friends to the user with a tillable field for a message; and send the message to selected mutual channels or friends provided on the selectable list of mutual channels or friends.

In another aspect of the invention, a system is implementing within a social networking environment. The system comprises an interface providing a selection of mutual channels or friends between a user and a user's current contact. The interface further provides a mechanism to send or post an electronic message to selected ones of the mutual channels or friends. The system further comprises an interface to view the post of the electronic message from the social networking environment and reply to the electronic message from an application resident in the social networking environment.

In yet another aspect of the invention, a computer system for sending and receiving electronic messages. The system comprises a CPU, a computer readable memory and a computer readable storage media. The system further comprises first program instructions to obtain a selectable list of mutual channels or friends of the user and a current contact or friend within a networking environment. The system further comprises second program instructions to provide the selectable list of mutual channels or friends to the user with a tillable field for a message. The system further comprises third program instructions to post the message to selected mutual channels or friends provided on the selectable list of mutual channels or friends. The system further comprises fourth program instructions to review the message from the user, in an interface within a social networking environment. The first, second, third and fourth program instructions are stored on the computer readable storage media for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 an illustrative environment for implementing the processes in accordance with aspects of the invention;

FIGS. 2-4 show various interfaces provided by the systems and methods in accordance with aspects of the invention; and

FIG. 5 shows a flow diagram implementing processes in accordance with aspects of the invention.

### DETAILED DESCRIPTION OF THE INVENTION

The invention relates to networking environments and, more particularly, to systems and methods of communicating in one or more networking environments. More specifically, the present invention provides a mechanism for communicating amongst mutual channels (friends) over any social networking application. For example, the social networking environments can be any type of social network application such as Facebook®, Google+®, Linkedin®, Bing®, etc. In addition, the present invention can equally be implemented in other social networking environments, as well as through other networking applications. For example, the present invention can be implemented through or with email applications, text messaging applications, and blogging applications, e.g., Twitter®, etc. Advantageously, the present invention can be integrated directly into the above social networking environments, using the application programming interface (API) of the host social network. In alternative embodiments, the present invention can be implemented as a standalone interface, with any of the above applications.

In more specific embodiments, the present invention provides a mechanism and accompanying interface to communicate with mutual “friends” (also referred to as “channels”) using the above noted applications. More specifically, the present invention provides a communication channel between a user, his or her contacts and the contacts mutual channels. By way of implementations, all of the mutual channels can now be ascertained, and then shared with the user. Once ascertained and obtained (or provided), the user can select any or all of the mutual channels, in order to directly and easily communicate with the mutual channels through a seamless interface, without requiring the need to send individual communications to the mutual channels. For example, the user can obtain mutual channels of a friend “A”, and once selected one or more of these mutual channels are selected, the user can communicate directly with the mutual channels through a single shared post, email, etc. In addition, the communication can include or exclude the friend “A”.

### System Environment

The present invention may be embodied as a system, method or computer program product. The present invention may take the form of a hardware embodiment, a software embodiment or an combination of software and hardware. Furthermore, the present invention may take the form of a computer program product embodied in any tangible storage medium of expression having computer-usable program code embodied in the medium. The computer-usable or computer-readable medium may be any medium that can contain, store, communicate, or transport the program for use by or in connection with an instruction execution system, apparatus, or device. The computer-usable or computer-readable medium may be, for example, an electronic, magnetic, optical, electromagnetic, infrared, or semiconductor system, apparatus, device, or propagation medium.

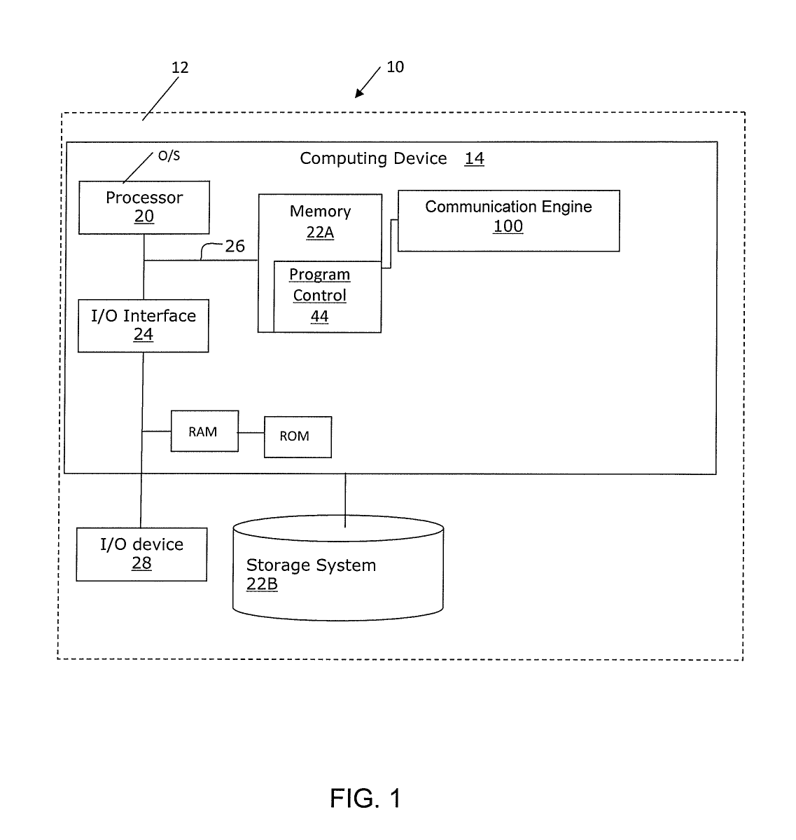

FIG. 1 shows an illustrative environment 10 for managing the processes in accordance with the invention. The environment 10 includes a server or other computing system 12 that can perform the processes described herein. The server 12 can be any server which is implementing, hosting, etc. a social network or other application, as described above. For example, the server 12 can be a host server for any social networking environment or communication application. In alternative embodiments, the server 12 can be a standalone server, which implements the processes of the present invention within the networking environment or communication application. That is, the server 12 and/or processes performed by the server 12 can be integrated into the networking environment or communication application.

The server 12 includes a computing device 14 which can be resident on a network infrastructure or computing device. The computing device 14 includes a processor 20, memory 22A, an I/O interface 24, and a bus 26. In addition, the computing device includes random access memory (RAM), a read-only memory (ROM), and an operating system (O/S). The computing device 14 is in communication with the external I/O device/resource 28 and the storage system 22B. The I/O device 28 can comprise any device that enables an individual to interact with the computing device 14 (e.g., user interface) or any device that enables the computing device 14 to communicate with one or more other computing devices using any type of communications link.

The processor 20 executes computer program code (e.g., program control 44), which can be stored in the memory 22A and/or storage system 22B. While executing the computer program code, the processor 20 can read and/or write data to/from memory 22A, storage system 22B, and/or I/O interface 24. The program code executes controls a communication engine 100 which , e.g., implements the processes described herein. The communication engine 100 can be implemented as one or more program code in the program control 44 stored in memory 22A as separate or combined modules. Additionally, the communication engine 100 may be implemented as separate dedicated processors or a single or several processors to provide the function of these tools. The program code executes the processes of the invention. The bus 26 provides a communications link between each of the components in the computing device 14.

The program code can include computer program instructions which are stored in a computer readable storage medium and can direct a computer, other programmable data processing apparatus, or other devices to function in a particular manner, including the computing infrastructure described herein. The computer program instructions may also be loaded onto a computer, other programmable data processing apparatus, or other devices to cause a series of operational steps to be performed on the computer. Moreover, any methods provided herein in the form of flowcharts, block diagrams or otherwise may be implemented using the computer program instructions, implemented on the computer readable storage medium.

The computer readable storage medium may be, for example an electronic, magnetic, optical, electromagnetic, infrared, and/or semiconductor system. More specific examples (a non-exhaustive list) would include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer readable storage medium may be any tangible medium that can contain, or store a program for use by or in connection with an instruction execution system, apparatus, or device of the present invention.

In more specific embodiments, the communication engine 100 provides a mechanism to communicate amongst mutual channels within a social network or other networking environment or application. For example, in one embodiment, the communication engine 100 can provide or determine mutual channels amongst friends or other contacts, and provide a listing of these mutual channels in an interface integrated within a social network or other networking environment or application. In embodiments, it is also contemplated by the present invention that the social network or other networking environment or application can determine the mutual channel information, itself (using its own application program interface (API)), and then provide this information to the interface of the present invention.

In embodiments, the interface of the present invention, which can be provided or implemented on any mobile device such as, for example, a smart phone, or using the external I/O device/resource 28 of FIG. 1, will provide a list of the mutual channels for selection by the user. The user can then select any combination of the mutual channels, including the current contact which shares the mutual channels. The user can then provide and send a message, using the interface of the present invention, to the mutual channels. In embodiments, this message can be posted to the account of the recipient within the social network or other networking environment or application. In this way, the recipient can simply read the post or, in alternative embodiments, select a hyperlink to an interface of the present invention, which will include the message.

Accordingly, the present invention is capable of providing a single message or post to any number of mutual channels. This, in effect, streamlines the processes of determining mutual channels amongst friends, for example, and providing separate messages to each of the mutual channels. In further embodiments, the communication engine 100 can also provide a notification text message, email or other type of notification to each of the mutual channels which are to receive the common communication via the systems and method of the present invention. For example, the underlying data associated with the mutual channels can include email address information, text message information, e.g., Twitter account information, or the like, which can be used to send a notification to the recipient.

In embodiments, the communication engine 100 can gather the mutual channel information from any number of sources, e.g., comparison of contacts within a database, contact lists for e-mail applications, etc. For example, the communication engine can be implemented within a mail server system. Specifically, in a mail server application, the communication engine 100 can determine common email addresses, amongst users, and provide this in a listed form. The user can then select from the list any combination of the mutual channels from the list, and send a single message which is directed to each of the email addresses. It should also be understood, that upon activation of the systems and/or processes of the present invention, an application icon can appear in the home page of the user, within the social network or other application. This facilitates access to the systems and/or processes of the present invention.

### Exemplary System Interfaces

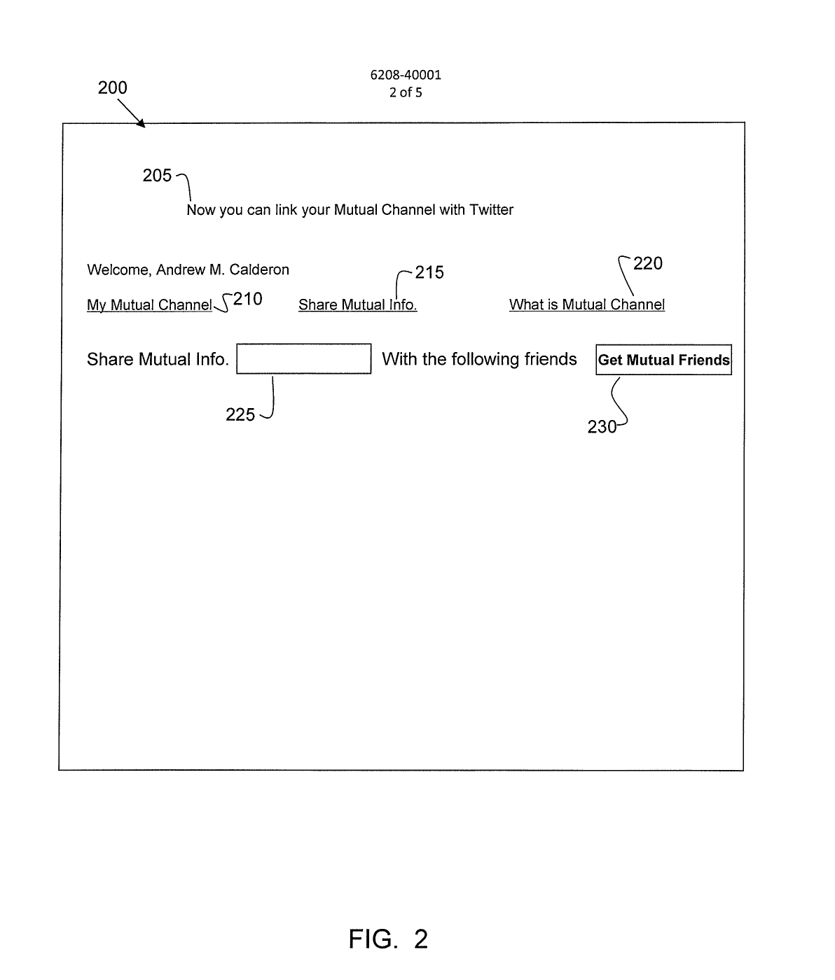

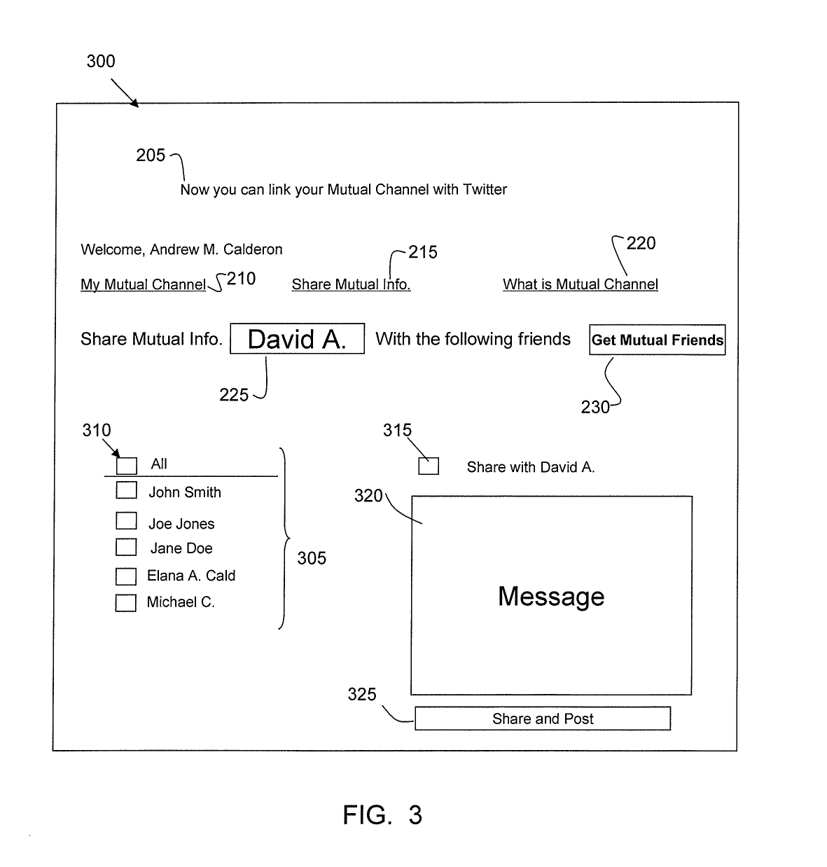

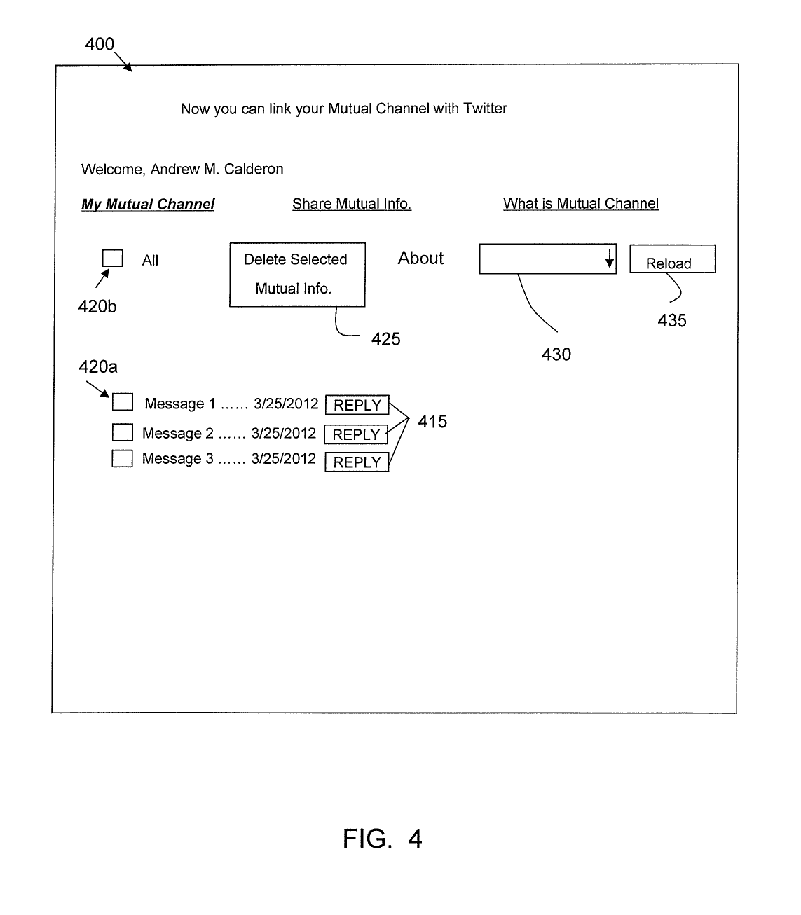

FIG. 2 shows an exemplary interface provided by the systems of the present invention. Prior to discussing the specific features of the interface of FIG. 2 (and interfaces of FIGS. 3 and 4), it should be understood by those of skill in the art that the descriptions of the fillable fields and buttons described herein are provided for only illustrative purposes, and that any appropriate descriptive terms can be interchangeably used with the present invention.

The interface 200 of FIG. 2 includes information to initially access and/or implement the processes and systems of the present invention. In particular, in embodiments, the interface 200 includes a “welcome” message 205 from the system of the present invention. It should be understood that the welcome message can include, for example, a greeting or any relevant notifications. The interface 200 further includes: (i) “my mutual channel” link 210, “share mutual information” link 215 and “what is mutual channel” link 220.

As should be understood by those of ordinary skill in the art, by selecting the “what is mutual channel” link 220, the user will be provided with a user friendly description of the present invention. In embodiments, the “my mutual channel” link 210 will direct the user to the interface shown in FIG. 4, for example, in order to find received messages. On the other hand, by selecting the “share mutual information” link 215, the interface 200 will then display a “share mutual information field” 225 which can be filled in by the user with a name or identification of a current contact. In embodiments, the “share mutual information field” 220 can either be a fillable field or a drop down menu of the current contacts of the user, within the specific networking application. For example, the current contact can be a friend in Facebook®, or any other contact within a social networking environment or network application, e.g., gmail™, etc.

Still referring to FIG. 2, the interface 200 also includes a command “button” 230, which can be clicked to obtain the mutual friends or contacts of the current contact and the requestor (user). Once the command button 230 is clicked, the system of the present invention, or the underlying social network application, etc. will obtain the mutual friends and provide this list in the interface 300 of FIG. 3. In embodiments, the list can be found by searching a database, contact list, etc., and making a comparison of the contacts of the user and the contacts of the current contact. Any matches will be provided to the interface 300 of FIG. 3.

The interface 300 of FIG. 3 includes a list of all mutual channels between the current contact (e.g., David A.) and the requestor (user of the system). In this illustrative, non-limiting example, the interface 300 will provide five mutual channels 305. In embodiments, the interface allows the user to select “All” of the mutual channels or any combination of the mutual channels by way of selection box 310. The interface 300 of FIG. 3 can provide the user with a selection box 315, which allows the user to send a message to the current contact, e.g., David A. In embodiments, the interface 300 further includes a message box 320. The message box 320 allows the user to enter a message, for sending to any combination of the selected contacts. Once the message is completed and the mutual channels are selected, the user can then send the message to each of the selected contacts by clicking the “share and post” button 325.

As should now be understood, once the “share and post” button 325 is clicking, a message is send to each of the selected mutual channels. The message, for example, can be posted to the recipients home page on the social networking environment. There, the recipient can link to the message on the interface of the present invention, as shown in FIG. 4, for example. In further embodiments, the message can be sent by any medium, e.g., email account, etc., depending on the underlying contact information provided with the selected mutual channels. In further embodiments, it is also contemplated by the present invention that a notification message can be sent to the selected recipients using text messaging using, e.g., Short Message Service (SMS), or other protocols, any of which are contemplated by the present invention.

FIG. 4 shows an interface 400 associated with the “my mutual channel” link 210. In embodiments, the interface 400 includes each of the messages 410 received by the recipient. In embodiments, the interface 400 is akin to an inbox in email applications. The messages 410 can include, for example, the sender's information, the date of receipt, as well as other user configurable information. In embodiments, the interface 400 further provides a mechanism to reply directly to the sender, via a selectable “reply” button 415. By selecting the “reply” button 415, the interface 400 will provide the user with a message box similar to that shown in FIG. 3. The message box can provide textual information, for example, about the recipient of the message.

As further shown in FIG. 4, the interface 400 further includes a mechanism to delete any or all of the messages. For example, check boxes 420a and 420b can be selected within a single interface of the networking environment, and by clicking (depressing) the “delete selected mutual information” button 425, the selected messages can be deleted. It should be understood by those of ordinary skill in the art that clicking and depressing can be used interchangeably herein. In alternative or additional embodiments, the user can select the “about” drop down menu 430, and click or depress the “reload” button 435, in order to provide selected messages for review, reply and/or deletion. The “about” drop down menu 430 can include different selections, so that the user can obtain specific messages. For example, the “about” drop down menu 430 can include a list of all contacts, all mutual channels, specific date ranges, or other information which can be used to obtain a selected range of messages.

### Flow Diagram

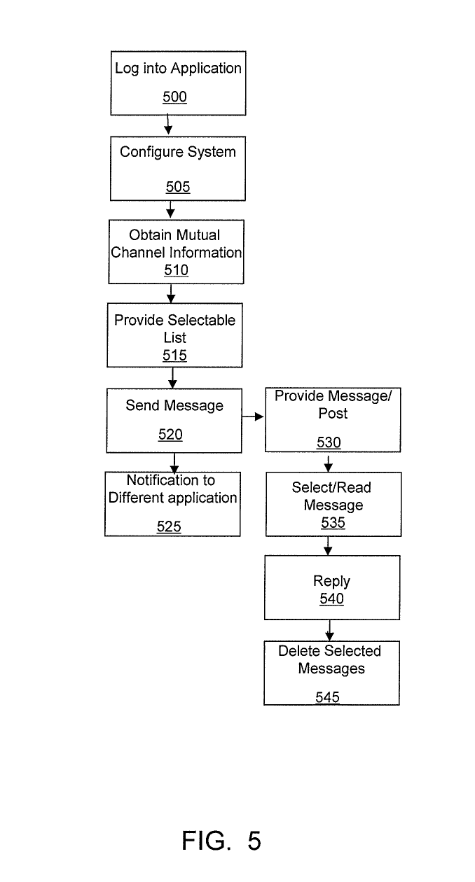

FIG. 5 shows a flow diagram implementing aspects of the present invention. The flow diagram may equally represent a high-level block diagram or a swim-lane diagram of the invention. The steps of the flow diagram may be implemented and executed from either a server, in a client server relationship, or they may run on a user workstation with operative information conveyed to the user workstation. Furthermore, the invention can take the form of a computer program product accessible from a computer-readable storage medium providing program code for use by or in connection with a computer or any instruction execution system. The software and/or computer program product can be implemented in the environment of FIG. 1.

More specifically, FIG. 5 shows the processes of the present invention. At step 500, a user can log into the system of the present invention. The log in can be, for example, provided by an application icon resident in a networking environment or a user's desktop, e.g., window of a mobile device, computing device, etc. At step 505, the user configures the system including, for example, requesting mutual channel information as described above. At step 510, the system of the present invention obtains the channel information. The mutual information can be obtained by the social network application or other networking application as discussed herein, e.g., by matching information (identification information of the mutual friends and/or contacts) within a database or contact list, etc. At step 515, the user is provided with a selectable list of mutual channels, in addition with a mechanism to provide a message to the selected mutual channels. In embodiments, the user can be provided with an interface, which includes mutual channels, requested by the user. At step 520, the system of the present invention sends the message to the selected mutual channels. At step 525, the selected mutual channels can be provided with a notification, by a SMS message or through other communication channels. In this way, the present invention can link, for example, a social networking site with another type of an account, e.g., email account, text messaging account, etc. For example, it is possible to follow the mutual messages on a Twitter® account, by simply inserting your Twitter® account identification into the systems of the present invention, and then insert the confirmation code that has been sent to you in Twitter® account as a direct message.

At step 530, the message is sent and/or displayed to the recipients (e.g., selected mutual channels). This can include, for example, posting a link of the message to the home page of the selected mutual channels, in a social networking environment. At step 535, the message can be opened and read by the recipient.

It should further be understood by those of ordinary skill in the art that the recipient can reply to the message or any message at step 540. It should be understood that the step 540 can occur at any time within the flow, by simply opening the application of the present invention and, thereafter, directing the application to the appropriate interface. Also, at step 545, which could also occur at any time within the flow, the user can select and delete any combination of received messages.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing examples have been provided for the purpose of explanation and should not be construed as limiting the present invention. While the present invention has been described with reference to an exemplary embodiment, Changes may be made, within the purview of the appended claims, without departing from the scope and spirit of the present invention in its aspects. Also, although the present invention has been described herein with reference to particular materials and embodiments, the present invention is not intended to be limited to the particulars disclosed herein; rather, the present invention extends to all functionally equivalent structures, methods and uses, such as are within the scope of the appended claims.

What is claimed:

1. A method implemented in a computer infrastructure having computer executable code tangibly embodied on a computer readable storage medium having programming instructions operable to:
obtain a selectable list of mutual channels or friends of the user and a current contact or friend within a networking environment;
provide the selectable list of mutual channels or friends to the user with a fillable field for a message; and
send the message to selected mutual channels or friends provided on the selectable list of mutual channels or friends.

2. The method of claim 1, wherein:
the providing of the selectable list of mutual channels or friends includes the current contact or friend; and
the sending of the message is also sent to the current contact or friend.

3. The method of claim 1, wherein the sending includes providing a post to a home page in the networking environment of the selected mutual channels or friends.

4. The method of claim 1, further comprising providing a notification to the selected mutual channels or friends to an application that is independent from the networking environment.

5. The method of claim 4, wherein the notification is provided by a direct messaging protocol.

6. The method of claim 1, wherein the current contact or friend is selectable by the user.

7. The method of claim 1, wherein the selectable list of mutual channels or friends is obtained by an application interface program of the networking environment.

8. The method of claim 1, wherein the selectable list of mutual channels or friends is obtained by an application interface program of an application different than the networking environment.

9. The method of claim 8, wherein the application interface program of the application is integrated into the networking environment.

10. The method of claim 1, wherein the selectable list of mutual channels or friends is obtained by matching identifications within a database or contact list provided on a server.

11. The method of claim 1, further comprising deleting selected messages provided within a single interface of the networking environment.

12. A system implementing within a social networking environment, comprising:
an interface providing a selection of mutual channels or friends between a user and a user's current contact, wherein the interface further provides a mechanism to send or post an electronic message to selected ones of the mutual channels or friends; and
an interface to view the post of the electronic message from the social networking environment and reply to the electronic message from an application resident in the social networking environment.

13. The system of claim 12, wherein the system is implemented in a computer program product comprising a computer usable storage medium having readable program code embodied in the storage medium, and the computer program product includes at least one component operable to implement the functionality of the system.

14. The system of claim 12, further comprising a mechanism to delete selected posts and electronic messages.

15. The system of claim 12, further comprising a notification mechanism to notify the selected mutual channels or friends of the post or electronic message.

16. The system of claim 15, wherein the notification mechanism provides the notification to the selected mutual channels or friends, independent of the social networking environment.

17. The system of claim 12, further comprising a mechanism to obtain the mutual channels of friends by searching a database or contact list.

18. A computer system for sending and receiving electronic messages, the system comprising:
a CPU, a computer readable memory and a computer readable storage media;
first program instructions to obtain a selectable list of mutual channels or friends of the user and a current contact or friend within a networking environment;
second program instructions to provide the selectable list of mutual channels or friends to the user with a fillable field for a message;
third program instructions to post the message to selected mutual channels or friends provided on the selectable list of mutual channels or friends; and
fourth program instructions to review the message from the user, in an interface within a social networking environment,
wherein the first, second, third and fourth program instructions are stored on the computer readable storage media for execution by the CPU via the computer readable memory.

19. The computer system of claim 18, further comprising fifth program instructions to send a reply to the message and provide the message as a post on a home page of the user, within the social networking environment.

20. The computer system of claim 18, wherein the first program instructions obtains the selectable list of mutual channels or friends from the social networking environment.
